(19) United States
(12) Patent Application Publication
(10) Pub. No.: US 2004/0230425 A1
(43) Pub. Date: Nov. 18, 2004

(54) Rate control for coding audio frames

(75) Inventors: Siu-Leong Yu, San Jose, CA (US); Christos Chrysafis, Mountain View, CA (US); Johnny Wang, Saratoga, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Divio, Inc., Sunnyvale, CA

(21) Appl. No.: 10/439,972

(22) Filed: May 16, 2003

(51) Int. Cl. G10L 19/12

(52) U.S. Cl. 704/223

(57) ABSTRACT

To determine the number of bits to encode a current audio frame, in accordance with a running average of the common scale factors for all preceding audio frames, a common scale factor for the-current frame is computed. The current frame is encoded using the computed common scale factor if the same falls within a defined range, and the number of bits required to so encode the frame also falls within a calculated range. If, the number of bits required to so encode the frame falls outside the calculated range, an energy level associated with the current frame and a running average of the energies of all previous frames is computed, which in turn, are used to compute a target bit rate. Thereafter, a common scale factor which results in coding of the current frame using a number of bits close to the target bit rate is obtained.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to audio frames, and more particularly to the control of bit rates for encoding of such frames.

Constant bit-rate and variable length encoding are both used to encode and store audio signals. In accordance with constant bit-rate encoding, a constant bit-rate is used to encode (i.e., compress) and/or store the audio signals. For example, many of the audio tracks stored on Compact Discs (CDs) are sampled at constant rates of 44.1 KHz or 48 KHz. If an audio track is stored at the constant rate of 44.1 KHz, 44100 samples per second are required in order to play back that track of the CD. For each audio channel, each sample point is typically represented by a 16-bit data. Therefore, when playing the track using, e.g., two channels, a throughput of 1.411 Mbits/sec (i.e., 44100*16*2=1.411 Mbits/sec) is required. This bit rate is constant and does not vary with time.

In accordance with variable length coding, a variable bit-rate is used to compress audio signals. Therefore, various parts of the signals are sampled at different rates and thus the compressed bit streams have variable bit rates at different times. For most transmission channels or media, the bit stream has a constant rate during any short period of time. Therefore, the decoding buffer that stores unused bits, does not typically suffer from underflow or overflow problem.

FIG. 1 illustrates the concept related to changing a variable bit rate to constant bit rate using a leaky bucket analogy. Assume that the bucket has a fixed size and has a hole at its bottom. The hole empties the water kept in the bucket at a constant rate, while the water may enter the bucket at different rates. The bucket (e.g., the decoding buffer) is so adapted as to ensure that the variable rate at which water enters the bucket does not cause the bucket to overflow (e.g., the decoding buffer is full and cannot store any more bits) or become empty (e.g., the decoding buffer does not have any unused bits).

In order to have high fidelity quality when playing back compressed audio, the compressed audio is required not to have a large amount of distortion. The smaller the distortion, the higher the fidelity and the higher is the bit rate required for compression. To meet both requirements of constant bit rate and high fidelity, a rate control algorithm is required for an audio codec (i.e., coder/decoder). Such a rate control algorithm regulates the bit rate so as to satisfy the virtual buffer requirement while keeping the compression distortion as small as possible.

In the Advanced Audio Coding (AAC) codec of the MPEG4 standard, each 2048 time-domain audio samples are transformed to 1024 frequency-domain data using a Modified Discrete Cosine Transform (MDCT). Assume Cᵢ, is the i-th MDCT coefficient of such a transformation, where i=0, . . . , 1023. These coefficients are grouped into N scale factor bands with size Lₖ, where k=0, . . . , N-1, where N may have a value from 16 to 49, and where

$${\sum }_{k = 0}^{N - 1} {L}_{k} = 1024.$$

The MDCT coefficients of k-th scale factor band are quantized using a non-uniform quantizer using a quantization step size sₖ=(Q−qₖ), as shown below:

$${x}_{i} = int ( {( \vert {C}_{i} \vert \times {2}^{\frac{1}{4} \times ( {q}_{k} - Q )} )}^{\frac{3}{4}} + m ) \qquad ( 1 )$$

In equation (1) above, xᵢ represents the i-th time-domain audio input sample, m is a constant equal to 0.4054, Q is the common scale factor, and qₖ is the k-th scale factor, which adjusts the common scale factor for k-th scale factor band, and int( ) is an operator that extracts the integer part of the numerical value inside the parenthesis. The scalar factors and common scale factor are transmitted in the bit stream and are used to reverse the quantization process during decoding. The quantized MDCT coefficients are coded using VLC and the results are used to form a compressed bit stream.

The larger the step size in quantization, the larger the distortion and the smaller the bit rate are. An effective rate control maintains the smallest possible quantization step size while keeping the output bit stream constant. The output bit rate may be varied by varying the values of a number of control parameters. If, for example, the output bit rate fails to satisfy the virtual buffer limitations, the frame needs to be encoded using different parameter values. Typically several iterations are required before an acceptable output bit rate is achieved. Because the output bit rate is not known until the frame is encoded, bit rate control is a time-consuming and challenging task

A widely known technique for bit rate control, commonly known as a two-loop technique, and described in the publication: “ISO/IEC 14496-3, Information Technology—Generic Coding of Audiovisual Objects, Part 3: Audio, Subpart 4: General Audio Coding: AAC/TwinVQ”, quantizes the MDCT coefficients in an iterative process in accordance with several requirements. An inner loop quantizes the coefficients and increases the quantization step size until the output can be coded with the available number of bits. Thereafter—following completion of the inner loop—an outer loop checks the distortion associated with each scale factor band. If the distortion of a scale factor band exceeds a predefined limit, the band is amplified by increasing its scale factor and the inner loop operation is reengaged.

As described above, the two-loop technique is adapted to find the common scale factor Q and scale factors qₖ for each scale band, k=0, . . . , N-1, concurrently. Since this involves solving multi-dimensional optimization problem with many unknowns, it poses a challenging task. The problem is further compounded by the requirement that for each set of unknowns, the audio frame is encoded once to find the number of encoding bits, which may require a large number of computations. Moreover, there are situations when the inner and outer loops may require a large number of iterations, e.g., 25, to converge. In other situations the inner and outer loops may not converge, which may require the loops to be terminated after a few iterations. Such terminations may lead to a set of scale factors and common scale factor values that result in large distortions. Moreover, the virtual buffer may suffer from overflow or underflow.

A need continues to exist for rate control algorithm that requires a relatively few iteration to find a set of quantization step sizes, and ensures that buffer overflows or underflows do not occur.

### BRIEF SUMMARY OF THE INVENTION

In accordance with one aspect of the present invention, to determine the number of bits with which a current audio frame is encoded, first a minimum bit rate and a maximum bit rate for encoding of the current frame is established. Both the minimum bit rate and maximum bit rate are defined by (i) the number of bits currently stored in a buffer, (ii) the maximum number of bits that the buffer is adapted to store and (iii) an average bit rate. Next, in accordance with a running average of the common scale factors for all audio frames preceding the current audio frame, a common scale factor for the current frame is computed. If the computed common scale factor falls within a defined range, it is used to encode the frame. If the number of bits required to so encode the frame falls within the established minimum and maximum bit rates, the encoding is complete and the next frame is received.

If, on the other hand, the number of bits required to so encode the frame falls outside the established minimum and maximum bit rates, an energy level associated with the frame is computed. Also, a running average of the energies of all previous frames is computed. The energy level and the running average of the energies are used to compute a target bit rate. Thereafter, using any one of a number of optimization techniques, such a bisection algorithm, a common scale factor which results in coding of the current frame using a number of bits close to the target bit rate is obtained, e.g., a number of bits which is within 5% of the target bit rate.

In some embodiments of the present invention, the minimum and maximum number of bit rates Bₘᵢₙ and Bₘₐₓ are defined in accordance with the following:

$$\begin{matrix}{B}_{min} = \{ \begin{matrix}0 & if {U}_{n} > {B}_{avg} \\ {B}_{avg} - {U}_{n} & if {U}_{n} \leq {B}_{avg}\end{matrix} \\ {B}_{max} = {U}_{max} - {U}_{n} + {B}_{avg}\end{matrix}$$

In these embodiments, the common scale factor Qₙ for the current frame may computed using the running average of common scale factors θₙ of audio frames preceding the current audio frame in accordance with the following:

$${Q}_{n} = {θ}_{n} + round ( {σ}_{1} ( {ψ}_{n} - \frac{{σ}_{2}}{8} ) ) ;$$

wherein θₙ is defined by:

θₙ=(1−α)Qₙ₋₁+αθₙ₋₁

wherein σ₁ and σ₂ are programmable parameters, wherein ψₙ represent the buffer fullness defined by

$${ψ}_{n} = \frac{{U}_{n}}{{U}_{max}} ,$$

wherein round( ) is an operator rounding the value of its operand, wherein θₙ is defined by θₙ=(1−α)Qₙ₋₁+αθₙ₋₁, wherein Qₙ₋₁ is a common scale factor for an audio frame preceding the current frame and wherein θₙ₋₁ is a running average of common scale factors of audio frames preceding the frame preceding the current audio frame.

In some embodiments of the present invention, the minimum and maximum common scale factors Qₘᵢₙ and Qₘₐₓ which define the range against which the computed common scale factor is compared are defined as following:

$$\begin{matrix}{Q}_{min} = [ \frac{- 16}{3} {log}_{2} \frac{{2}^{13} - m}{M} ] \\ {Q}_{max} = [ \frac{- 16}{3} {log}_{2} \frac{1 - m}{M} ]\end{matrix}$$

wherein m is a constant and wherein M is defined as

$$M = {Max}_{i} ( {\vert {C}_{i} \vert}^{3 / 4} ) , i = 0 , … , 1023$$

wherein Cᵢ is the i-th MDCT coefficient associated with the current audio frame.

In some embodiments, the energy level eₙ associated with the frame and the running average of energies Eₙ of the audio frames preceding the current audio frame are defined by:

$$\begin{matrix}{e}_{n} = \frac{1}{N} {\sum }_{i = 0}^{N - 1} \vert {c}_{i} \vert & & & {E}_{n} = ( 1 - β ) {\sum }_{i = - ∞}^{0} {β}^{- i}\end{matrix} {e}_{i + n - 1}$$

In these embodiments, the target bit rate B₁ₙ is further defined by:

$${B}_{1 n} = {( \frac{{e}_{n}}{{E}_{n}} )}^{{σ}_{0}} {B}_{avg} - \frac{1}{8} round ( {σ}_{1} ( {ψ}_{n} - \frac{{σ}_{2}}{8} ) ) {B}_{avg}$$

where σ₀ is a programmable parameter.

In accordance with another aspect of the present invention, a rate control technique is adapted to optimize the common scale factor Q for each frame using scale factors qₖ that have selected values and thus do not require optimization. Accordingly, because the common scale factor Q for each frame becomes the only unknown, the rate control of the present inventions reduces the amount of computation required for obtaining the quantized MDCT coefficients. Moreover, the tradeoff between quantization distortion and output bit rate is achieved by varying the common scale factor Q.

In some embodiments, all scale factors qₖ are selected to have the same constant value. In other embodiments, because humans are most sensitive to lower frequency signals, the scale factors associated with lower frequency bands are selected to have smaller values than those associated with lower frequency bands. In yet other embodiments, a look-up table may be used to select scale factors qₖ values based on the frequency characteristic of the audio frame being encoded. Furthermore, in accordance with human acoustic responses, the scale factors may be selected such that larger step sizes are used for the scale factor bands that can tolerate larger quantization distortion.

In accordance with yet another aspect of the present invention, the same common scalar factor Q is used for each channel of multi-channel system. Moreover, the scalar factors selected for one channel of a multi-channel system, as described above, together with one or more offset values are used to define the scalar factors of the remaining channels of such a system. In other words, after the scalar factors for one channel of a multi-channel system is selected, they are modified by corresponding offset values to determine the scalar factors for the remaining channels. In some embodiments, all the offsets for all channels may be select to be equal to a constant. In other embodiments, the offsets are selected in accordance with the complexity of the channel, such as the energy associated with the frames forwarded to that channel.

### BRIEF DESCRIPTION OF THE DRAWINGS

FIG. 1 illustrates a leaky bucket adapted to absorb variations in the incoming flow rate to generate a constant outgoing flow.

FIG. 2 is a graph of number of bits used in encoding of an audio frame as a function of common scale factor, in accordance with one embodiment of the present invention.

FIG. 3 is a flow-chart of steps carried out in determining bit rates for encoding audio frames, in accordance with one embodiment of the present invention.

### DETAILED DESCRIPTION OF THE INVENTION

In accordance with a first aspect of the present invention, a rate control technique predicts the common scale factor Q for a current frame using previous common scale factors. If the common scale factor Q so predicted leads to buffer underflow or overflow, an optimization algorithm is used so that the number of bits remains close to a target value and within a defined limit. In some embodiments, the rate control technique predicts the common scale factor Q in accordance with the buffer fullness and a running average of previous common scale factors, as described further below.

Assume that Uₙ is the number of bits in the virtual buffer when encoding the n-th frame. Assume ψₙ represents the buffer fullness, i.e., the percentage of the buffer that is filled. For example, a value of 0.25 means that 25% of the buffer is filled. Note that 0≦ψₙ≦1, and

$${ψ}_{n} = \frac{{U}_{n}}{{U}_{max}} \qquad ( 2 )$$

where Uₘₐₓ is the size of buffer.

Assume further that B_{avg} is the target bit rate. Therefore, to inhibit virtual buffer underflow and overflow, the bit rate is required to fall in a range defined by Bₘᵢₙ, and Bₘₐₓ, where:

$$\begin{matrix}{B}_{min} = \{ \begin{matrix}0 & if & {U}_{n} > {B}_{avg} \\ {B}_{avg} - {U}_{n} & if & {U}_{n} \leq {B}_{avg}\end{matrix} & ( 3 ) \\ {B}_{max} = {U}_{max} - {U}_{n} + {B}_{avg} & ( 4 )\end{matrix}$$

To predict common scale factor Qₙ, a running average θₙ of all previous common scale factors is calculated, as shown below:

$${θ}_{n} = ( 1 - α ) {\sum }_{i = - ∞}^{0} {α}^{- i} {Q}_{i + n - 1} \qquad ( 5 )$$

where α is a user-defined programmable parameter, which controls the weighting of previous common scale factors. In some embodiments, α is defined to have a value of, e.g., 0.9 or 15/16. Equation (5) may be simplified as:

θₙ=(1−α)Qₙ₋₁+αθₙ₋₁ (6)

Accordingly, Qₙ may be predicted using the following equation:

$${Q}_{n} = {θ}_{n} + round ( {σ}_{1} ( {ψ}_{n} - \frac{{σ}_{2}}{8} ) ) \qquad ( 7 )$$

where the function round returns the nearest integer of its argument. As seen from equation (7), Qₙ may be varied by the difference between the buffer fullness and a reference value. Both parameters σ₁ and σ₂ are programmable. In some embodiments, σ₁ is selected to be an integer ranging from 0 to 15, i.e., σ₁ ε {0, 1, . . . , 15} and σ₂ is selected to be an integer ranging from 0 to 8, i.e., σ₂ ε {0, 1, . . . , 8}. A value of 4 for σ₂ defines a condition where the buffer is half full.

Common scale factor Qₙ is further required to remain within boundary limits Qₘᵢₙ and Qₘₐₓ. Therefore, if Qₙ as computed above, falls below Qₘᵢₙ it is set to Qₘᵢₙ. Similarly, if Qₙ as computed above exceeds Qₘₐₓ, it is set Qₘₐₓ, as shown below:

$${Q}_{n} = \{ \begin{matrix}{Q}_{min} & if & {Q}_{1 n} < {Q}_{min} \\ {Q}_{max} & if & {Q}_{1 n} > {Q}_{max}\end{matrix} \qquad ( 8 )$$

In some embodiments, Qₘᵢₙ and Qₘₐₓ, which together define the limits of Qₙ, are computed as follows. Assume M represents the maximum value of the absolute values of MDCT coefficients raised to the three-fourth power of a current frame:

$$M = {Max}_{i} ( {\vert {C}_{i} \vert}^{3 / 4} ) , i = 0 , … , 1023 \qquad ( 9 )$$

where Cᵢ is the i-th MDCT coefficient. Assume that all the quantized MDCT coefficient are required to be in the range of [0, 2^{13].} Therefore, as seen from equation (1), the minimum and maximum possible common scale factors Qₘᵢₙ and Qₘₐₓ are defined as below:

$$\begin{matrix}{Q}_{min} = [ \frac{- 16}{3} {log}_{2} \frac{{2}^{13} - m}{M} ] & ( 10 ) \\ {Q}_{max} = [ \frac{- 16}{3} {log}_{2} \frac{1 - m}{M} ] & ( 11 )\end{matrix}$$

Equations (10) and (11) may further be simplified if m is selected to be, e.g., 0.4054, as shown below:

$$\begin{matrix}{Q}_{min} = [ \frac{- 16}{3} {log}_{2} \frac{{2}^{13}}{M} ] & ( 12 ) \\ {Q}_{max} = [ \frac{- 16}{3} {log}_{2} \frac{0.5}{M} ] & ( 13 )\end{matrix}$$

As described above, in accordance with the present invention, common scale factor Qₙ derived from equation (8) is used to encode the current frame. If the resulting bit rate Bₙ is within the range defined by Bₘᵢₙ, and Bₘₐₓ, the encoding is declared as being successful, and the next frame becomes subject to encoding. If, on the other hand, the resulting bits rate Bₙ falls outside the range defined by Bₘᵢₙ, and Bₘₐₓ, the common scale factor Qₙ, is varied so as to result in a bit rate Bₙ, that falls within this range. If, the resulting bits rate Bₙ is less than B_{min.}, the virtual buffer is filled by the number of dummy bits defined by the difference between these two rates, e.g., Bₘᵢₙ-Bₙ, and the frame is encoded using a filing encoding mode, as known in the prior art. The dummy bits are ignored by the decoder.

To vary the common scale factor Qₙ so as to encode the frame with a bit rate Bₙ that falls within the range defined by Bₘᵢₙ, and Bₘₐₓ, in accordance with a second aspect of present invention, an energy level associated with the current frame is first computed. The energy level, in accordance with the present invention, is a measure of the complexity of the current frame relative to all other previous frames. Because each frame is adapted to be encoded using a number bits related to its relative energy level, audio distortions are kept relatively small. Assume en represent the energy in L₁ norm and associated with the frame prior to encoding:

$${e}_{n} = \frac{1}{N} {\sum }_{i = 0}^{N - 1} \vert {c}_{i} \vert \qquad ( 14 )$$

Assume further that Eₙ represents the running average of the energies associated with all the frames except the current frame:

$${E}_{n} = ( 1 - β ) {\sum }_{i = - ∞}^{0} {β}^{- i} {e}_{i + n - 1}$$

Energy Eₙ may thus be estimated using the following equation:

=(1−β)eₙ₋₁+βEₙ₋₁ (15)

where β is a user-defined programmable parameter, affecting the weight associated with the energies of the previous frames. Using equation (15), a target bit B₁ₙ for the frame is defined as follows:

$${B}_{1 n} = {( \frac{{e}_{n}}{{E}_{n}} )}^{{σ}_{0}} {B}_{avg} - \frac{1}{8} round ( {σ}_{1} ( {ψ}_{n} - \frac{{σ}_{2}}{8} ) ) {B}_{avg} \qquad ( 16 )$$

In some embodiments, parameter σ₀ has a value of, e.g., zero or one. If σ₀ is selected to have a value of 0, the target bit rate is adjusted from the average bit rate B_{avg} in accordance with the buffer fullness. Therefore, if the buffer approaches fullness, the desired bit rate is decreased and vice versa. If σ₀ is selected to have a value of 1, the ratio of the energies eₙ and Eₙ are used to compute the target bit rate. If the energy of current frame eₙ is higher than the running average energy Eₙ, a larger target bit rate is used. If the energy of current frame eₙ is higher than the running average energy Eₙ, a larger target bit rate is used. To inhibit buffer underflow and overflow, the target bit is required to be within a minimum Bₘᵢₙ and a maximum value Bₘₐₓ, as defined below:

$${B}_{1 n} = \{ \begin{matrix}{B}_{min} & if & {B}_{1 n} < {B}_{min} \\ {B}_{max} & if & {B}_{1 n} < {B}_{max}\end{matrix} \qquad ( 17 )$$

Therefore, a common scale factor Qₙ which results in an output bit rate that is close to the target bit rate B₁ₙ is obtained. In one embodiment, a bisection algorithm is used to find a Qₙ within lower and upper limits described in equations (12) and (13) and that would yield a rate close to the target rate, as described further below.

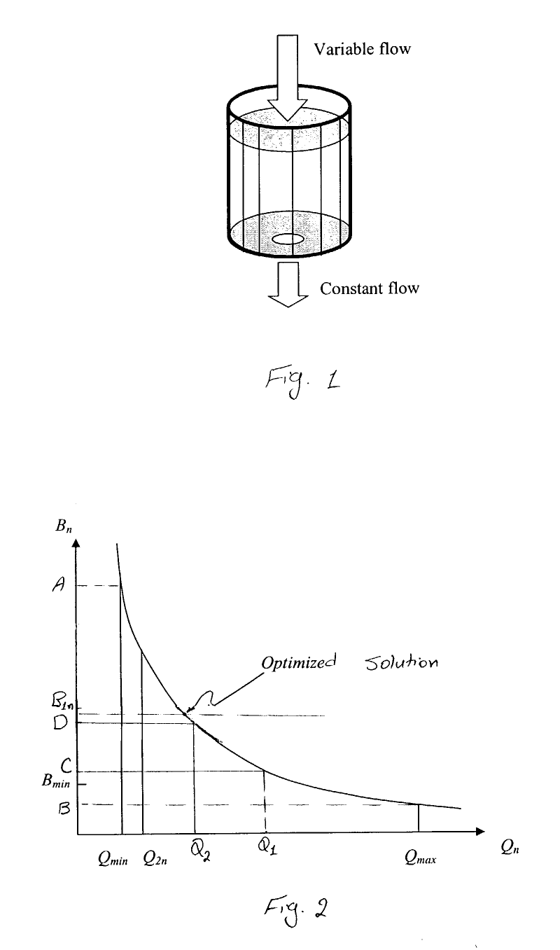

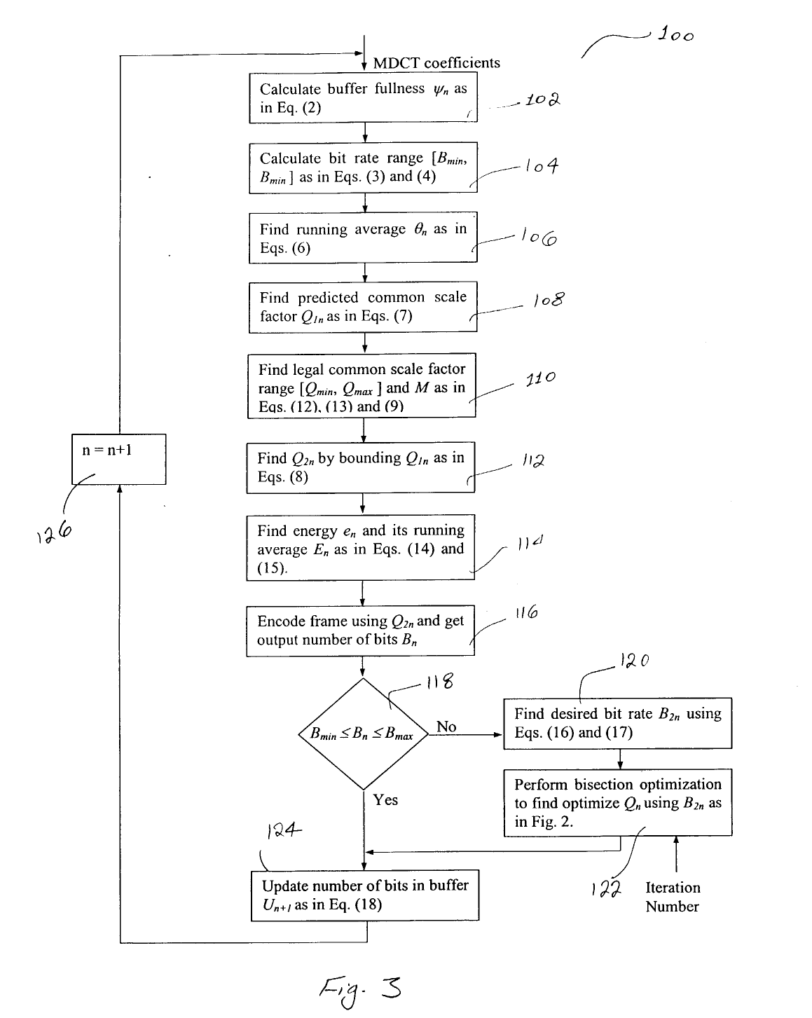

FIG. 2 shows the bit rates used for encoding as a function of the common scale factor Qₙ used for this encoding. As seen from FIG. 2, the smaller the Qₙ, the larger is the bit rate that is used for encoding, and vice versa. To optimize Qₙ, a pair of bit rates that would result from encoding the frame using Qₘᵢₙ and Qₘₐₓ are obtained. These bit rates are shown in FIG. 2 as points A and B. Next, the bit rate that would result from a Qₙ which is half the sum of Qₘᵢₙ and Qₘₐₓ is obtained, shown in FIG. 2 as Q₁. Next the target rate that would result from encoding the frame using Q₁ is obtained, shown in FIG. 2 as point C. Because target bit rate the bit rate B₁ₙ, is shown as being between Bₘₐₓ and C, the frame is next encoded using common scale factor Q₂ which is half the sum of Qₘᵢₙ and Q₁, which is shown in FIG. 2 as causing a bit rate D. As is understood by people skilled in the art, this process continues until an optimized common scale factor Qₒₚₜ that result in a bit rate that is close to target bit rate B₁ₙ is obtained. Typically, after a few iterations, e.g. 5, the optimization is completed.

In some embodiments, to further reduce computations, Qₘₐₓ may be used as the optimum solution, in which case the virtual buffer is filled with corresponding dummy bits, as known to those skilled in the art. In yet other embodiments, the Q₁ₙ as defined in equation (8) is used as Qₘᵢₙ. Following encoding of the frame, the number of bits in the virtual buffer that are used for encoding the next frame is updated as shown below:

U_{n+1=U}ₙ+Bₙ−B_{avg} (18)

FIG. 3 shows a flow-chart 100 for predicting Qn as described above. In step 102, buffer fullness ψₙ, defined in equation (2), is calculated. Next, in step 104, minimum and maximum bit rates Bₘᵢₙ, Bₘₐₓ, defined in equations (3) and (4) are calculated. Next, in step 106, a running average θₙ of all previous common scale factors is calculated. Next, in step 108, as shown in equation (7), common scale factor Qₙ is predicted. Next, in step 110, minimum and maximum common scale factors Qₘᵢₙ, Qₘₐₓ as well as the maximum value of the absolute values of MDCT coefficients raised to the three-fourth power M of a current is calculated, as shown in equations (12), (13) and (9). Next, in step 112, common scale factor Qₙ is compared against Qₘᵢₙ, Qₘₐₓ and is set to Qₘᵢₙ if it is less than Qₘᵢₙ or is set to Qₘₐₓ if it is greater than Qₘₐₓ, as described in equation (8). Next, in step 114, energy eₙ of the current frame and a running average of the energies associated with all the previous frames Eₙ are computed. Next, in step 116, the frame is encoded using the common scale factor obtained in step 112 and the number of bits used to encode Bₙ is obtained. Next, in step 118, Bₙ is compared against the range defined by Bₘᵢₙ and Bₘₐₓ. If Bₙ is not within this range, in step 120, bit rate Bₙ is obtained, as defined in equations (16) and (17). Next, in step 122, bisection optimization is performed to find optimized Qₙ and Bₙ. Next, in step 124, the number of bits in the virtual buffer is updated. If Bₙ is within this range defined by Bₘᵢₙ and Bₘₐₓ, the algorithm moves to step 124 to update the number of bits in the virtual buffer. Next, in step 126, the next frame to be encoded is received and the process moves to step 102.

In accordance with a third aspect of the present invention, a rate control technique is adapted to optimize the common scale factor Q for each frame using scale factors qₖ that have selected values and thus do not require optimization. Accordingly, because the common scale factor Q for each frame becomes the only unknown, as seen from equation (1) above, the rate control of the present inventions reduces the amount of computation required for obtaining the quantized MDCT coefficients. Moreover, the tradeoff between quantization distortion and output bit rate is achieved by varying the common scale factor Q.

In some embodiments, all scale factors qₖ are selected to have the same constant value. In other embodiments, because humans are most sensitive to lower frequency signals, the scale factors associated with lower frequency bands are selected to have smaller values than those associated with lower frequency bands. In yet other embodiments, a look-up table may be used to select scale factors qₖ values based on the frequency characteristic of the audio frame being encoded. Furthermore, in accordance with human acoustic responses, the scale factors may be selected such that larger step sizes are used for the scale factor bands that can tolerate larger quantization distortion.

In accordance with a fourth aspect of the present invention, the same common scalar factor Q is used for each channel of multi-channel system. Moreover, the scalar factors selected for one channel of a multi-channel system, as described above, together with one or more offset values are used to define the scalar factors of the remaining channels of such a system. In other words, after the scalar factors for one channel of a multi-channel system is selected, they are modified by corresponding offset values to determine the scalar factors for the remaining channels. In some embodiments, all the offsets for all channels may be select to be equal to a constant. In other embodiments, the offsets are selected in accordance with the complexity of the channel, such as the energy associated with the frames forwarded to that channel.

The above embodiments of the present invention are illustrative and not limitative. Other additions, subtractions or modification are obvious in view of the present invention and are intended to fall within the scope of the appended claims.

What is claimed is:

1. A method for encoding of a current audio frame, the method comprising:
establishing minimum bit rate Bₘᵢₙ and maximum bit rate Bₘₐₓ for the current frame, Bₘᵢₙ and Bₘₐₓ being defined by a number of bits Uₙ stored in a buffer, maximum number of bits that the buffer is adapted to store Uₘₐₓ and an average bit rate B_{avg};
establishing a running average of common scale factors θₙ of audio frames preceding the current audio frame;
computing a common scale factor Qₙ for the current frame using θₙ;
encoding the current frame using Qₙ if Qₙ falls within a range defined by a minimum common scale factor value Qₘᵢₙ and a maximum common scale factor value Qₘₐₓ; and
verifying that encoding the current frame using Qₙ requires a number of bits Bₙ that falls within a range defined by Bₘᵢₙ and Bₘₐₓ.

2. The method of claim 1 further comprising:
computing an energy level eₙ associated with the current frame if Bₙ does not falls within Bₘᵢₙ and Bₘₐₓ;
computing a running average of energies Eₙ of the audio frames preceding the current audio frame;
computing a target bit rate B₁ₙ associated with the current frame using eₙ and Eₙ;
determining a common scale factor Qₙ that results in a number of bits close to B₁ₙ when the current frame is encoded therewith.

3. The method of claim 2 wherein said Bₘᵢₙ and Bₘₐₓ are defined in accordance with the following:
$${B}_{min} = \{ \begin{matrix}0 & if & {U}_{n} > {B}_{avg} \\ {B}_{avg} - {U}_{n} & if & {U}_{n} \leq {B}_{avg}\end{matrix} \\ {B}_{max} = {U}_{max} - {U}_{n} + {B}_{avg} .$$

4. The method of claim 3 wherein the common scale factor Qₙ is computed using the running average of common scale factors θₙ of audio frames preceding the current audio frame in accordance with the following:
$${Q}_{n} = {θ}_{n} + round ( {σ}_{1} ( {ψ}_{n} - \frac{{σ}_{2}}{8} ) ) ;$$
wherein θₙ is defined by:
θₙ=(1−α)Qₙ₋₁+αθₙ₋₁
wherein σ₁ and σ₂ are programmable parameters, wherein ψₙ represent the buffer fullness defined by
$${ψ}_{n} = \frac{{U}_{n}}{{U}_{max}} ,$$
wherein round( ) is an operator rounding the value of its operand, wherein θₙ is defined by θₙ=(1−α)Qₙ₋₁+αθₙ₋₁, wherein Qₙ₋₁ is a common scale factor for an audio frame preceding the current frame and wherein θₙ₋₁ is a running average of common scale factors of audio frames preceding the frame preceding the current audio frame.

5. The method of claim 4 wherein said Qₘᵢₙ and Qₘₐₓ are defined as follows:
$${Q}_{min} = [ \frac{- 16}{3} {log}_{2} \frac{{2}^{13} - m}{M} ]$$
$${Q}_{max} = [ \frac{- 16}{3} {log}_{2} \frac{1 - m}{M} ]$$
wherein m is a constant and wherein M is defined as:
$$M = {Max}_{i} ( {\vert {C}_{i} \vert}^{3 / 4} ) , i = 0 , … , 1023$$
wherein Cᵢ is the i-th MDCT coefficient associated with the current audio frame.

6. The method of claim 5 wherein the energy level en associated with the current frame is defined by:
$${e}_{n} = \frac{1}{N} {\sum }_{i = 0}^{N - 1} \vert {c}_{i} \vert$$
and wherein the running average of energies Eₙ of the audio frames preceding the current audio frame is defined by:
$${E}_{n} = ( 1 - β ) {\sum }_{i = - ∞}^{0} {β}^{- i} {e}_{i + n - 1}$$

7. The method of claim 6 wherein the target bit rate B₁ₙ is defined by:
$${B}_{1 n} = {( \frac{{e}_{n}}{{E}_{n}} )}^{{σ}_{0}} {B}_{avg} - \frac{1}{8} round ( {σ}_{1} ( {ψ}_{n} - \frac{{σ}_{2}}{8} ) ) {B}_{avg}$$
and wherein σ₀ is a programmable parameter.

8. The method of claim 2 further comprising:
updating the number of bits in the buffer after the current frame is encoded.

9. The method of claim 7 wherein Qₒₚₜ is determined using a bisection algorithm.

10. The method of claim 2 further comprising:
assigning a value to each of a plurality of scale factors qₖ associated with the current audio frame.

11. The method of claim 2 wherein the current frame is received in a multi-channel system and wherein the common scale factor Qₙ is used for encoding the current frame associated with each channel of the multi-channel system.

12. The method of claim 11 further comprising:
assigning a value to each of a plurality of scale factors qₖ of the current associated with a first channel of the multi-channel system; and
defining offsets between scale factors of the first channel and those of other channels of the multi-channel system.

13. an apparatus adapted to set bit rate for encoding of a current audio frame, the apparatus comprising:
a module adapted to establish minimum bit rate Bₘᵢₙ and maximum bit rate Bₘₐₓ for the current frame, Bₘᵢₙ and Bₘₐₓ being defined by a number of bits Uₙ stored in a buffer, maximum number of bits that the buffer is adapted to store Uₘₐₓ and an average bit rate B_{avg};
a module adapted to establish a running average of common scale factors θₙ, of audio frames preceding the current audio frame;
a module adapted to compute a common scale factor Qₙ for the current frame using θₙ;
a module adapted to encode the current frame using Qₙ if Qₙ falls within a range defined by a minimum common scale factor value Qₙ and a maximum common scale factor value Qₘₐₓ; and
a module adapted to verify that encoding the current frame using Qₙ requires a number of bits Bₙ that falls within a range defined by Bₘᵢₙ and Bₘₐₓ.

14. The apparatus of claim 13 further comprising:
a module adapted to compute an energy level en associated with the current frame if Bₙ does not falls within Bₘᵢₙ and Bₘₐₓ;
a module adapted to compute a running average of energies Eₙ of the audio frames preceding the current audio frame;
a module adapted to compute a target bit rate B₁ₙ associated with the current frame using eₙ and Eₙ; and
a module adapted to determine a common scale factor Qₒₚₜ that results in a number of bits close to B₁ₙ when the current frame is encoded therewith.

15. The apparatus of claim 14 wherein said Bₘᵢₙ and Bₘₐₓ are defined in accordance with the following:
$${B}_{min} = \{ \begin{matrix}0 & if & {U}_{n} > {B}_{avg} \\ {B}_{avg} - {U}_{n} & if & {U}_{n} \leq {B}_{avg}\end{matrix} \\ {B}_{max} = {U}_{max} - {U}_{n} + {B}_{avg} .$$

16. The apparatus of claim 15 wherein the common scale factor Qₙ is computed using the running average of common scale factors θₙ of audio frames preceding the current audio frame in accordance with the following:
$${Q}_{n} = {θ}_{n} + round ( {σ}_{1} ( {ψ}_{n} - \frac{{σ}_{2}}{8} ) ) ;$$
wherein θₙ is defined by:
θₙ=(1−α)Qₙ₋₁+αθₙ₋₁
wherein σ₁ and σ₂ are programmable parameters, wherein ψₙ represent the buffer fullness defined by
$${ψ}_{n} = \frac{{U}_{n}}{{U}_{max}} ,$$
wherein round( ) is an operator rounding the value of its operand, wherein θₙ is defined by θₙ=(1−α)Qₙ₋₁+αθₙ₋₁, wherein Qₙ₋₁ is a common scale factor for an audio frame preceding the current frame and wherein θₙ₋₁ is a running average of common scale factors of audio frames preceding the frame preceding the current audio frame.

17. The apparatus of claim 16 wherein said Qₘᵢₙ and Qₘₐₓ are defined as follows:
$${Q}_{min} = [ \frac{- 16}{3} {log}_{2} \frac{{2}^{13} - m}{M} ]$$
$${Q}_{max} = [ \frac{- 16}{3} {log}_{2} \frac{1 - m}{M} ]$$
wherein m is a constant and wherein M is defined as:
$$M = {Max}_{i} ( {\vert {C}_{i} \vert}^{3 / 4} ) , i = 0 , … , 1023$$
wherein Cᵢ is the i-th MDCT coefficient associated with the current audio frame.

18. The apparatus of claim 17 wherein the energy level eₙ associated with the current frame is defined by:
$${e}_{n} = \frac{1}{N} {\sum }_{i = 0}^{N - 1} \vert {c}_{i} \vert$$
and wherein the running average of energies Eₙ of the audio frames preceding the current audio frame is defined by:
$${E}_{n} = ( 1 - β ) {\sum }_{i = - ∞}^{0} {β}^{- i} {e}_{i + n - 1}$$

19. The apparatus of claim 18 wherein the target bit rate B₁ₙ is defined by:
$${B}_{1 n} = {( \frac{{e}_{n}}{{E}_{n}} )}^{{σ}_{0}} {B}_{avg} - \frac{1}{8} round ( {σ}_{1} ( {ψ}_{n} - \frac{{σ}_{2}}{8} ) ) {B}_{avg}$$
and wherein σ₀ is a programmable parameter.
